(19) United States
(12) Patent Application Publication
(10) Pub. No.: US 2006/0018744 A1
(43) Pub. Date: Jan. 26, 2006

(54) Heavy duty lift adaptor for vehicle towing

(76) Inventor: C. Thomas Luciano, Pottersville, NY (US)

Correspondence Address: MICHAEL P. MAZZA, LLC, 686 CRESCENT BLVD., GLEN ELYN, IL, 60137, US

(21) Appl. No.: 10/884,763

(22) Filed: Jul. 2, 2004

(51) Int. Cl. B60P 3/12

(52) U.S. Cl. 414/563

(57) ABSTRACT

Lift adaptors for the hook-up and towing of heavy vehicles such as trucks, buses and trailer-tractors in a damage-free fashion, avoiding the need for pre-picking. The lift adaptors may be connected to receivers slidable over the underlift crossbar of heavy-duty, underlift-type tow vehicles. A movable boom may be used to locate the crossbar in a proper position beneath the towed vehicle, enabling engagement to the lift adaptors. The lift adaptors may be connected to the same receivers that may also be connected to forks, for example.

### BACKGROUND OF THE INVENTION

The present invention relates to heavy duty lift adaptors for the hook-up and towing of large vehicles in a damage-free fashion.

Light vehicle recovery has developed damage-free towing operations utilizing, for example, wheel lifts such as those described in U.S. Pat. Nos. 4,836,737 and 4,798,509. Such lifting apparatus is not suitable for the recovery of heavy vehicles such as trucks, buses or tractor-trailer combinations.

Heavy duty wheel lifts are available. However, these are fairly time-consuming to hook-up. Also, special installation is required for their use, and towers may not desire this.

Large vehicle recovery trucks known as heavy-duty “underlifts” have been developed for towing heavy vehicles. These underlifts have rugged, heavy-duty truck hitches or underlifts which may be fitted with forks or other apparatus. Recovery of heavy vehicles using underlift vehicles has long suffered from several problems. Towing of such vehicles is commonly prefaced by pre-picking them. “Pre-picking” involves extending the underlift of the towing vehicle, initially without the use of forks, and picking up the vehicle on the bottom of the rear end “pumpkin” (lowest part). Because the pumpkin is typically offset to one side, pre-picking usually does not result in a square lift. Once lifting has been accomplished in this fashion, wooden blocking is placed under the tires of the vehicle to be towed. Blocked, the towed unit is at a sufficient height to allow the underlift, now fitted with forks, to be engaged for towing. However, the use of wooden blocking is a safety issue, as the towed vehicle can roll or slide off the blocking. Underlift forking can damage the air bags, brakes, suspension parts, lights, mudflaps, etc., of the towed vehicle. Pre-picking can be a time-consuming and labor-intensive operation, and can also result in damage to fragile suspension parts of the towed vehicle.

Accordingly, it would be advantageous to provide a heavy duty lift adaptor designed for use with underlift vehicles that could be used to hook-up and tow heavy vehicles in a safe, damage-free fashion, without the need for pre-picking.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Heavy vehicles” means vehicle Classes 7 (26,001-33,000 pounds GVWR (gross vehicle weight rating)) and 8 (33,001 pounds and over, GVWR), per DOT Classification (TRAA Vehicle Identification Guide), which includes a wide range of heavy vehicles, including large delivery trucks, motor coaches, refuse trucks, cement mixers, all tractor trailer combinations including double trailers, etc.

“Recovery vehicle” means a vehicle to retrieve and, if necessary, lift other tow vehicles.

“Tow” means the act of transporting a vehicle from one point to another by a second vehicle.

“Tow vehicle” means a vehicle used to lift and/or tow other vehicles.

“Underlift” means a device used for towing vehicles by lifting one end of the towed vehicle from under the axle or structural member.

### SUMMARY OF THE INVENTION

The objects mentioned above, as well as other objects, are solved by the present invention, which overcomes disadvantages of prior heavy duty vehicle towing apparatus, while providing new advantages not believed associated with such devices.

In a preferred embodiment of the invention, a lift adaptor is provided which is used by a towing and/or recovery vehicle having an underlift crossbar supporting slidable receivers, to tow a vehicle from the rear of the towing and/or recovery vehicle. The lift adaptor includes an engagement end and a distal end. The distal end is supported by the receiver mounted on the crossbar. The engagement end is designed to receive and support an underside portion of the towed vehicle, which underside portion (such as a U-bolt or saddle) may be connected to the frame or axle housing of the towed vehicle. Preferably the adaptor, including its engagement end, has a cylindrical cross-section, though other cross-sections may be employed.

In one preferred embodiment, the adaptor has a substantially decreased inner diameter, and an inner tapering portion facilitating a secure connection with the underside portion of the towed vehicle. While the lift adaptor of the present invention may be used to tow vehicles of various sizes, such as Class 5-8 vehicles, it is believed that it will find particularly advantageous application with “heavy” vehicles of Classes 7 and 8.

A method for towing vehicles using a heavy-duty towing and/or recovery vehicle having an underlift crossbar with a movable boom is also disclosed and claimed. In one preferred method, the crossbar of the underlift, towing vehicle (which may or may not be of the wheel-lift-integrated variety), mounts two or more slidable receivers. Each of these receivers supports a lift adaptor. The crossbar is positioned so that the lift adaptors are located below underside portions of the towed vehicle to be engaged by the adaptor. Now the crossbar is raised, while maintaining the boom in a position generally parallel to the towed vehicle frame, engaging the lift adaptors with the underside portions of the towed vehicle. The crossbar is continued to be raised until the towed vehicle is placed in an appropriate towing position.

If desirable, the lift adaptor may be easily removed from the receivers so that it may be replaced with forks or tire lifts, for example.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings. The drawings illustrate currently preferred embodiments of the present invention. As further explained below, it will be understood that other embodiments, not shown in the drawings, also fall within the spirit and scope of the invention.

FIG. 1 is a perspective view of a preferred embodiment of the lift adaptors of the present invention, seated on slidable receivers located on an underlift crossbar supported by a rearward, movable boom;

FIG. 2 is an enlarged perspective view of one of the lift adaptors shown in FIG. 1, aligned below a portion of the towed vehicle to be engaged by the lift adapator;

FIG. 3 is a view similar to FIG. 2 showing the adaptor engaged to the towed vehicle, with safety chains secured;

FIG. 4 is a rear perspective view of the engaged, towed vehicle in towing position;

FIG. 5 is an enlarged, perspective view of the adaptor shown in FIG. 3, taken from the opposite side of the view shown in FIG. 3;

FIGS. 6 and 7 are side and front, part views, respectively, of a preferred embodiment of the lift adaptor, with hidden parts shown in section; and

FIG. 8 is a perspective view of a conventional heavy-duty, underlift-type towing and/or recovery vehicle that may be used in connection with the present invention.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

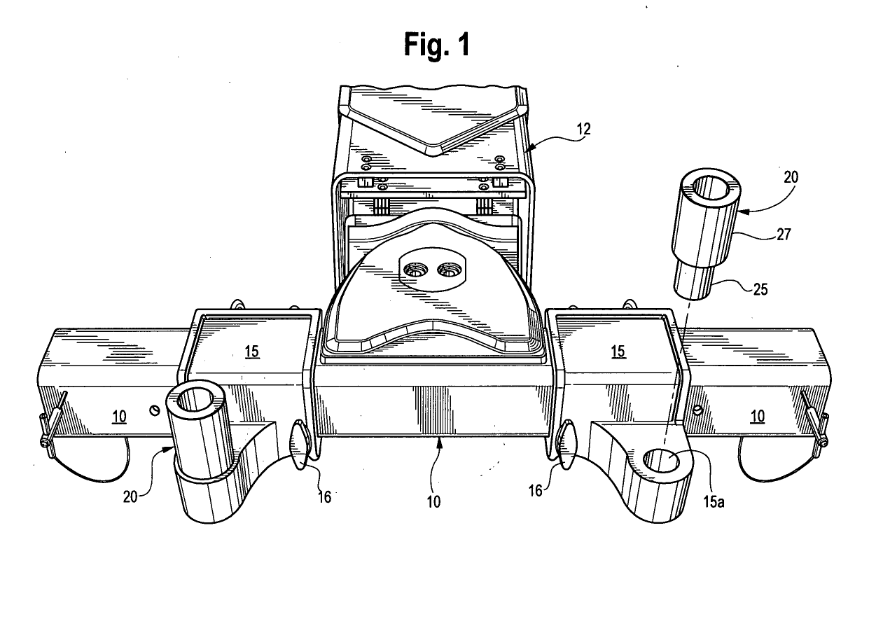

Referring first to FIG. 1, a preferred embodiment of the heavy duty lift adaptor of the present invention is shown, designated generally with the reference numeral 20. Lift adaptor 20 includes a distal end 25 which may be slid within aperture 15a of receiver 15, and an engagement end 27. Receivers 15 are slid over each end of underlift crossbar 10, which is attached to movable boom 12. Receivers 15 may be also be designed for connecting forks (not shown). Threaded pins 16 may be used to lock receivers 15 in position along the length of underlift cross bar 10.

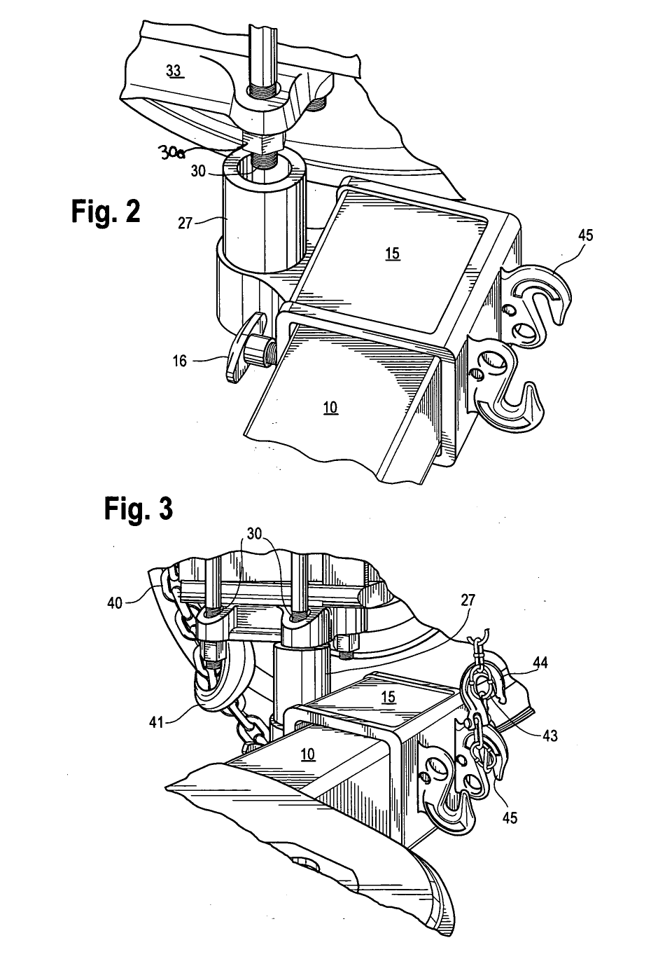

Referring to FIG. 2, underlift cross bar 10 may be extended out and positioned below the rear U-bolts 30, for example, of the underside 33 of a towed truck. Once lift adaptors 20 are properly aligned, the cross bar may be raised, locking adaptor engagement ends 27 into the desired U-bolts 30, as shown in FIG. 3. Inner taper 27c of lift adaptors 20 facilitates centering of the U-bolt nut 30a (FIG. 2) into the adaptor aperture.

The towed vehicle may now be raised to a desired towed position.

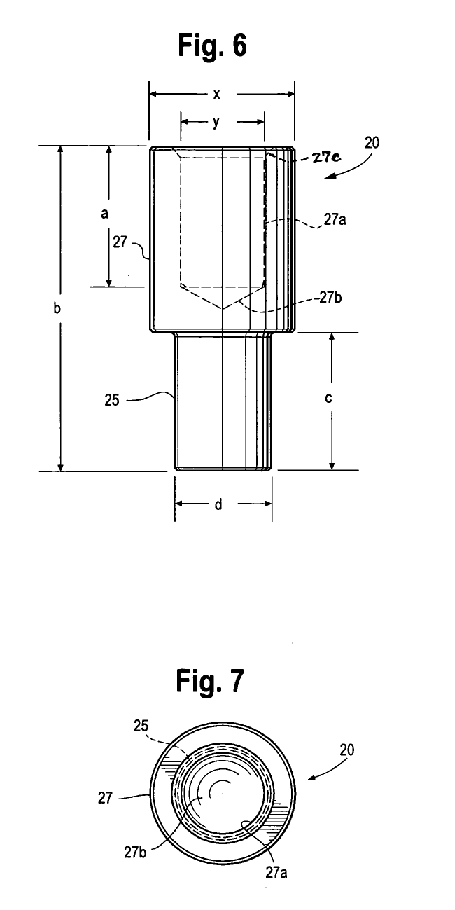

Referring now to FIGS. 6 and 7, in a preferred embodiment engagement end 27 of adaptor 20 may include a decreased inner diameter portion 27a with a tapering end 27b to more securely engage U-bolts 30, for example. In a preferred embodiment, adaptor 20 has the following dimensions, though other dimensions may be designed for difference vehicles, different connection applications, etc.: long width “x” (3 inches); inner height before taper “a” (3 inches); overall height “b” (7 inches); short height “c” (3 inches); short width “d” (2 inches); an inner bore size “y” (1¾ inches); and angle gamma (45°).

Referring back to FIG. 3, as a primary securing device, chain 43 may be attached to hook 45 on the front of fork receiver 15, and then may be routed straight up and over the top of the frame rails of the towed vehicle (not shown) and down to the fork receiver on the opposite side where it is secured using hook 44, to secure and eliminate the chance of separation of the towed unit from the receivers. An underlift tie-down strap (not shown) may also be used as a primary securing device.

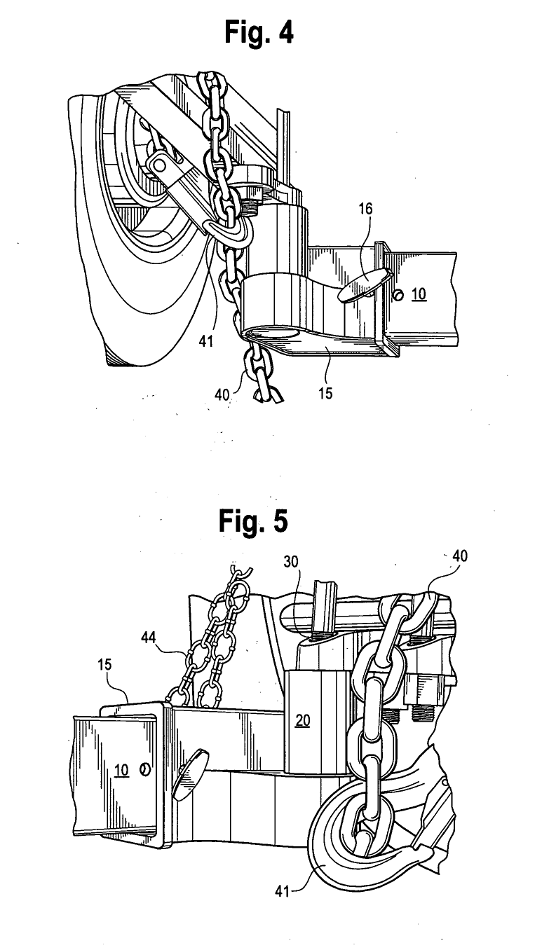

Referring now to FIGS. 4 and 5, as a secondary securing device safety chain 40 may be attached to the hook on the front of the fork receiver, then routed over the top of the frame rails.

Still referring to FIGS. 4 and 5, the towed vehicle, now properly secured and chained to the underlift crossbar. Using the present invention, it is not necessary to tilt the underlift in order to squarely seat the lift adaptors 20 on the bottom of the spring saddle. Preferably, the underlift boom is maintained in a generally parallel location to the towed vehicle frame, so that the adaptors are fit square on the saddle. It will also be understood that hook-up, lifting and towing using the present invention may be accomplished without the need to contact any other components of the towed truck than those identified above, and without concern for damaging air suspension parts, airlines, brake cans, cam shafts, electrical wiring, tail lights, etc.

In the past, there may have been some concern in utilizing a relatively small lift adaptor for heavy-duty vehicle recovery. However, it should now be understood and appreciated that the underlift crossbar and the receivers carry most of the transferred weight of the towed vehicle. In contrast, lift adaptors 20 primarily constrain the towed vehicle from front-and-back movement. In any event, for safety, adaptors according to the present invention are designed to provide a carrying capacity of up to 26,000 pounds used with Class 7 or Class 8 vehicles.

As described above, the lift adaptor of the present invention is intended to be used for rear tows only. An adaptor in a front steering application should not be used because it may become wedged between the adaptor and the front axle beam, potentially causing the U-bolt to bend or deform. Accordingly, for front tows, forks and tire lifts should be used.

To properly employ the lift adaptor of the present invention in a rear hook-up, for safety reasons, the front drive axle should be chained before raising the towed vehicle to a towed position. This eliminates hyper-extension of the raised front drive axle, which may cause damage. Also prior to raising the towed vehicle to a towed position, if the invention is used with a towed vehicle having air ride suspension, the suspension should first be placed in the deflate mode.

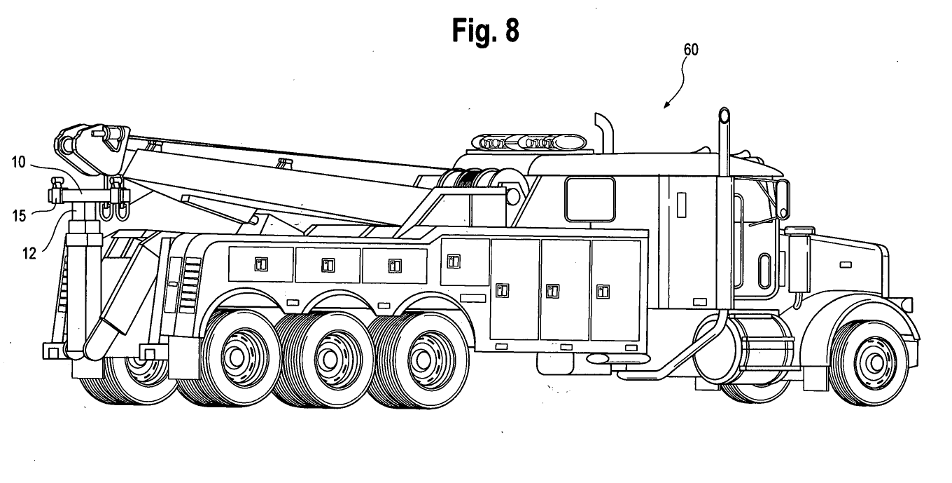

Referring now to FIG. 8, the adaptors of the present invention may be used with virtually any type of underlift 60 having appropriately-sized fork receivers with a hole diameter of two inches, including conventional units such as the Century Super Duty and Challenger Heavy Duty Underlifts, as well as wheel-lift-type integrated units such as the Century 7035 or the Vulcan V100, all of which are available from Miller Industries, Inc.

Class 7 and Class 8 vehicles typically employ a ⅞-inch U-bolt having a 1 5/16-inch nut. The bore size 27a of adaptor 20 must be large enough to accommodate these nuts, without permitting excessive horizontal and lateral movement of the U-bolt with respect to the adaptor. On the other hand, if bore size 27a too closely matches the nut size, wedging can occur, which could result in the U-bolt bending. For Class 7 and 8 vehicles, it was experimentally determined that an adaptor with a cylindrical cross-section having an inner bore size “y” (FIG. 6) of 1¾-inches is preferred.

Adaptors with rectangular or other cross-sectional designs are not preferred because they tend not to fit saddles having raised gussets and/or they allow excessive movement.

It will be understood that various modifications to the preferred embodiment disclosed above may be made. The above description is not intended to limit the meaning of the words used in the following claims that define the invention. Rather, it is contemplated that future modifications in structure, function or result will exist that are not substantial changes and that all such insubstantial changes are intended to be covered by the following claims.

I claim:

1. A lift adaptor used by a tow vehicle to tow a second vehicle from the rear of the tow vehicle, the tow vehicle having an underlift crossbar supporting slidable receivers, the lift adaptor comprising:
an engagement end and a distal end, the distal end supported by the receiver, and the engagement end designed to receive and support an underside portion of the second vehicle.

2. The lift adaptor of claim 1, wherein the adaptor has a cylindrical cross-section.

3. The lift adaptor of claim 1, wherein the adaptor has a substantially decreased inner diameter.

4. The lift adaptor of claim 1, wherein the adaptor has an inner tapering portion facilitating a secure connection with the underside portion of the second vehicle.

5. The lift adaptor of claim 1, wherein the underside portion of the second vehicle is connected to the frame of the tow vehicle.

6. The lift adaptor of claim 1, wherein the underside portion comprises a U-bolt.

7. The lift adaptor of claim 1, wherein the lift adaptor is designed to be used for Class 7 and Class 8 vehicles.

8. A lift adaptor used by a heavy-duty tow vehicle to tow a second, heavy vehicle from the rear of the tow vehicle, the tow vehicle having an underlift crossbar supporting slidable receivers, the lift adaptor comprising:
an engagement end and a distal end, the distal end supported by the receiver, and the engagement end designed to receive and support an underside portion of the second vehicle.

9. A method for towing vehicles using a heavy-duty tow vehicle having an underlift crossbar with a movable boom, comprising the steps of:
providing the crossbar with two or more receivers, each of the receivers mounting a lift adaptor;
positioning the crossbar so that the lift adaptors are positioned below underside portions of a second vehicle to be towed;
raising the crossbar while maintaining the boom in a position generally parallel to the towed vehicle frame, to engage the lift adaptors with the underside portions of the towed vehicle; and
continuing to raise the crossbar until the towed vehicle is placed in an appropriate towing position.

10. The method of claim 9, wherein the underside portions of the towed vehicle comprise U-bolts attached to an axle housing of the towed vehicle.

11. The method of claim 9, wherein the underside portions of the towed vehicle comprise saddles connected to the frame of the towed vehicle.

12. The method of claim 9, wherein the engagement end of the adaptor has a generally circular cross-section.

13. The method of claim 10, wherein the adaptor has an inner tapering portion facilitating a secure connection with the underside portions of the towed vehicle.

14. The method of claim 10, wherein the heavy-duty tow vehicle comprises a wheel-lift integrated underlift.

15. The method of claim 10, further comprising the step of quickly replacing the adaptors in the field with forks.

16. The method of claim 10, further comprising the step of quickly replacing the adaptors in the field with other hook-up, tow or recovery attachment devices.
